(19) United States
(12) Patent Application Publication
(10) Pub. No.: US 2026/0358497 A1
(43) Pub. Date: Nov. 12, 2026

(54) Method and Device for Detecting an Object in a Near Field of an Ultrasonic Transducer

(71) Applicant: Elmos Semiconductor SE, Lerverkusen (DE)

(72) Inventor: Egbert Spiegel, Marl (DE)

(21) Appl. No.: 19/667,865

(22) Filed: May 5, 2026

(30) Foreign Application Priority Data
May 7, 2025 (EP) 25174792.9

(51) Int. Cl. G01S 15/04; G01S 15/00; G01S 15/931

(52) U.S. Cl. CPC G01S 15/04; G01S 15/006; G01S 15/931; G01S 2015/932

(57) ABSTRACT

The invention relates to a method for detecting an object in a near field of an ultrasonic transducer, in particular as a parking aid for a vehicle. The method includes the steps of cyclic acquisition of measured values, each cycle of the measured-value acquisition including emitting an ultrasonic signal by an ultrasonic transducer into a detection region to be monitored; receiving, by the ultrasonic transducer, an ultrasonic signal reflected by an object in the detection region in the form of an ultrasonic reception signal; and determining a phase derivative of the ultrasonic reception signal at least for a near-field region of the ultrasonic transducer. The method further includes the step of comparing the phase derivative for the near-field region with a phase derivative of a preceding cycle, wherein the presence of an object in the near field of the ultrasonic transducer is inferred on the basis of the comparison.

### CROSS-REFERENCE TO RELATED APPLICATION

This application claims priority to European Patent Application No. 25174792.9 filed May 7, 2025, the disclosure of which is hereby incorporated by reference in its entirety.

### BACKGROUND OF THE INVENTION

### Field of the Invention

The present invention relates to a method for detecting an object in a near field of an ultrasonic transducer, in particular as a parking aid for a vehicle. The present invention further relates to a device for implementing such a method, as well as to a system comprising at least one ultrasonic transducer and such a device.

### Description of Related Art

The detection of an obstacle particularly in the surroundings of a vehicle, by means of analyzing a received echo signal from previously emitted ultrasonic waves is known in principle. Such methods have proven effective in automotive applications, for example as a parking aid.

In such methods, usually an ultrasonic transducer is used, which is excited to emit an ultrasonic signal into a detection region to be monitored. The ultrasonic signal is then reflected by an obstacle in the detection region and so returns to the ultrasonic transducer. The ultrasonic transducer is then excited by the reflected ultrasonic received signal, wherein the excitation of the ultrasonic transducer is used as a measurement signal for detecting the obstacle in the detection region.

In particular, in case of very close obstacles, which are located at a small distance from the ultrasonic transducer, the reflected ultrasonic reception signal can return to the ultrasonic transducer already during the excitation of the ultrasonic transducer that generates the originally emitted ultrasonic signal or during a ring-down time, during which the vibration/oscillation of the ultrasonic transducer generating the ultrasonic signal decays or rings down after the end of the excitation. Thus, the oscillation of the ultrasonic transducer caused by the active excitation and by the ring-down vibration after the end of the excitation overlaps with the reflected ultrasonic reception signal, which has so far rendered the acquisition of the ultrasonic reception signal and thus the detection of an obstacle impossible or barely possible.

### SUMMARY OF THE INVENTION

The object of the invention is to provide a method for detecting an obstacle or object in a near field of an ultrasonic transducer.

The object is achieved by a method for detecting an object in a near field of an ultrasonic transducer, a device, and a system described herein.

According to the present invention, a method is provided for detecting an object or obstacle in a near field of an ultrasonic transducer, in particular as a parking aid for a vehicle. The method comprises the steps of:
cyclic acquisition of measured values, each cycle of the measured-value acquisition comprising:
   emitting an ultrasonic signal by an ultrasonic transducer into a detection region to be monitored,
   receiving, by the ultrasonic transducer, an ultrasonic signal reflected by an object or obstacle in the detection region in the form of an ultrasonic reception signal,
   determining a phase derivative of the ultrasonic reception signal at least for a near-field region of the ultrasonic transducer.

Then, a comparison of the phase derivative, i.e. the derivative of the phase of the ultrasonic reception signal, for the near-field region with a phase derivative of a preceding cycle is made according to the invention, wherein the presence of an object in the near field of the ultrasonic transducer is inferred on the basis of this comparison. Thus, the present method comprises at least two measured-value acquisitions, wherein in each measured-value acquisition an ultrasonic signal is emitted and an ultrasonic reception signal is received by the ultrasonic transducer. In particular, the measured-value acquisition is executed continuously, so that, for example, an object entering into the near field of the ultrasonic transducer during a movement of the vehicle can be detected. After the end of the excitation of the ultrasonic transducer, it continues to oscillate for a certain time. This time is referred to as the ring-down region, or decay region, and usually lasts a few hundred microseconds and in particular less than 1.5 ms. In particular, the ring-down region lasts between 300 μs and 800 μs. In the ring-down region of the ultrasonic transducer, it is still in motion due to the ringing-down excitation. Thus, if there is an obstacle in the near field of the ultrasonic transducer, the ultrasonic signal returns to the ultrasonic transducer within a very short time due to the short propagation time in such a way that the excitation of the ultrasonic transducer caused by the reflected ultrasonic signal overlaps with the ringing-down motion of the ultrasonic transducer. When this is the case, the ringing-down oscillation of the ultrasonic transducer is disturbed by the reflected ultrasonic signal received by the ultrasonic transducer. This leads to a change in the oscillation/vibration, which can be determined by the phase derivative and by comparing the phase derivatives of two successive cycles. Thus, if there is an obstacle in the near field of the ultrasonic transducer, the decay behavior of the ultrasonic transducer changes, as can be detected in the form of a difference in the phase derivatives of two successive cycles of the ultrasonic signal. Thus, the presence of an obstacle in the near field of the ultrasonic transducer can be inferred by comparing the phase derivative for the near-field region with a phase derivative of a preceding cycle. It has been shown here that the use of the phase derivative creates a particularly robust system and the phase derivatives of successive cycles can be compared in a simple manner. In particular, no static limit value is used for the change in the phase derivative. External influences, such as the temperature or the like, which have an influence on the oscillation behavior of the ultrasonic transducer thus have just no influence on the detection of the object in the near field of the ultrasonic transducer, since these influences are present in each of the successive measurement cycles.

Preferably, the phase derivative is determined at least for the near-field region of the ultrasonic transducer. Alternatively, the phase derivative is determined for the entire ultrasonic reception signal.

Preferably, the near-field region comprises at least partially a ring-down region of the ultrasonic transducer. The near-field region of the ultrasonic transducer is thus the time region of the ultrasonic reception signal, during which the ultrasonic transducer is excited to generate the ultrasonic signal and during which its excitation rings down. In this near-field region, usually no ultrasonic signal can be received by the ultrasonic transducer. Only the consideration of the phase derivative and the comparison of the phase derivative with a phase derivative of a preceding cycle enables the detection of an object in the near field of the ultrasonic transducer.

Preferably, a boost signal is added to the ultrasonic reception signal before the phase derivative is determined. In particular, at the end of the ring-down region of the ultrasonic transducer, the ultrasonic reception signal decreases so rapidly and becomes so small that the phase derivative can no longer be reliably determined in this region. The ultrasonic reception signal is thus boosted again by the boost signal, so that the respective phase derivative can be reliably determined and be used for a comparison with the phase derivative of a preceding cycle.

Preferably, the addition of the boost signal takes place in a baseband. In particular, the boost signal can be added as a constant to the ultrasonic reception signal.

In particular, a phase of the boost signal is selected as 45°, i.e. e^{iπ/4}, so that particularly when IQ signals are used, I and Q are uniformly controlled.

Preferably, the boost signal is defined as a saturation signal minus the maximum amplitude of the ultrasonic reception signal. Thus, the boost signal is controlled on the basis of the respective amplitude of the ultrasonic reception signal. The saturation signal corresponds to the maximum amplitude that can be processed in the respective signal path and is determined by the electronics used in the signal chain. In particular, the saturation signal is determined by an analog-digital converter, by means of which the acquired ultrasonic reception signal is converted into a digital signal. In particular, the saturation signal corresponds to a negative envelope of the ultrasonic reception signal.

Preferably, an evaluation window is defined in the near-field region of the ultrasonic transducer, in which the phase derivative is determined. In particular, the phase derivative is determined only in the evaluation window. Thus, the determination of the phase derivative can be limited to the evaluation window so as to limit this determination to the relevant region of the ultrasonic reception signal. It is therefore sufficient for the ultrasonic reception signal to be temporarily stored in the evaluation window and evaluated accordingly. This can reduce the required computing power. This also ensures that the comparison of the phase derivatives is not influenced by an echo signal in the far-field range of the ultrasonic reception signal. Furthermore, a temporary storage of the entire ultrasonic reception signal is not required, allowing a corresponding amount of memory to be saved.

Preferably, the evaluation window comprises a time range of 1 ms to 2.5 ms and in particular 1.5 ms to 2 ms.

Preferably, the position and width of the evaluation window are selected as a function of one or more of the decay time of the ultrasonic transducer, the temperature, the excitation current of the ultrasonic transducer, the quality factor of the ultrasonic transducer, the excitation frequency of the ultrasonic transducer, the number of excitation pulses of the ultrasonic transducer, and the excitation duration of the ultrasonic transducer. In particular, the evaluation window can begin with the excitation of the ultrasonic transducer. Preferably, the evaluation window begins with the end of the excitation of the ultrasonic transducer, i.e. with the beginning of the ring-down region of the ultrasonic transducer. Preferably, the evaluation window ends after the end of the ring-down region of the ultrasonic transducer. Thus, in particular the position and the width of the evaluation window are based on the ring-down region, which can be influenced by the parameters mentioned above.

Preferably, the phase derivative is determined from the IQ values of the ultrasonic reception signal. In particular, the phase derivative φ′(n) is determined according to φ′(n)=I(n−1).

(Q(n−2)−Q(n))−Q(n−1)·(I(n−2)−I(n)), wherein n denotes a discrete time step, I denotes the in-phase values and Q denotes the quadrature values of the ultrasonic reception signal.

Thus, the phase derivative φ′(n) is particularly an approximation which can be simply calculated in real time, i.e. in a single step using temporary storage of only a few discrete values of the ultrasonic reception signal.

Preferably, an envelope is determined from the ultrasonic reception signal for each cyclic measured-value acquisition. On the basis of the envelope, an echo signal can be detected, for example, in the far-field region of the ultrasonic reception signal, thereby enabling the presence of an object in the far field of the ultrasonic transducer to be inferred.

Preferably, comparing the phase derivative for the near-field region with a phase derivative of a preceding cycle comprises determining a difference between the phase derivatives and, if the difference is greater than a predetermined limit value, inferring the presence of an obstacle in the near field of the ultrasonic transducer. Thus, if the difference between the determined phase derivatives is greater than the predetermined limit value, it can be concluded that an obstacle is present in the detection region in the near field of the ultrasonic transducer.

Preferably, also the detection of an obstacle in the near field of the ultrasonic transducer is executed cyclically, in particular during each cyclic measured-value acquisition, to such an extent that the near field of the ultrasonic transducer can be continuously monitored following the second measured-value acquisition.

Preferably, the preceding cycle is the immediately preceding cycle. Alternatively, a cycle prior thereto can also be used for the comparison.

Preferably, the phase derivatives of more than one preceding cycle can be taken into account, wherein, for example, an averaging over the phase derivatives determined for the respective cycles is calculated and used for the comparison with the current measurement cycle.

Preferably, when an object is detected in the near field of the ultrasonic transducer, i.e. when a flag is set, this information is output to a user, for example via a warning signal. The warning signal can be an optical warning signal, for example, on a display. Alternatively or additionally, it is an acoustic warning signal and/or a haptic warning signal.

In a further aspect of the present invention, a device is provided, which is particularly configured in the form of a microelectronic circuit. The device is configured for connection to at least one ultrasonic transducer. The device comprises a memory unit and a processor, wherein the memory unit stores instructions which, when executed by the processor, implement the steps of the method described above.

Preferably, the microelectronic circuit is an integrated circuit, or an application-specific integrated circuit (ASIC), or an FPGA, or the like.

In a further aspect of the present invention, a system is provided comprising a device as described above and at least one ultrasonic transducer, which is connected to the device.

### BRIEF DESCRIPTION OF THE DRAWINGS

The invention is explained in more detail below on the basis of preferred embodiments with reference to the attached figures.

In the figures:

FIG. 1 shows a schematic flow diagram of a first embodiment of the present invention;

FIG. 2 shows a schematic flow diagram of a second embodiment of the present invention;

FIG. 3 shows a diagram of the method according to the present invention;

FIG. 4 shows an exemplary implementation of the method according to the present invention;

FIG. 5 shows an exemplary boost signal;

FIG. 6 shows an exemplary phase derivative diagram;

FIG. 7 shows an exemplary implementation of the comparison of the phase derivatives;

FIG. 8 shows an exemplary measurement; and

FIG. 9 shows a device according to the present invention.

### DESCRIPTION OF THE INVENTION

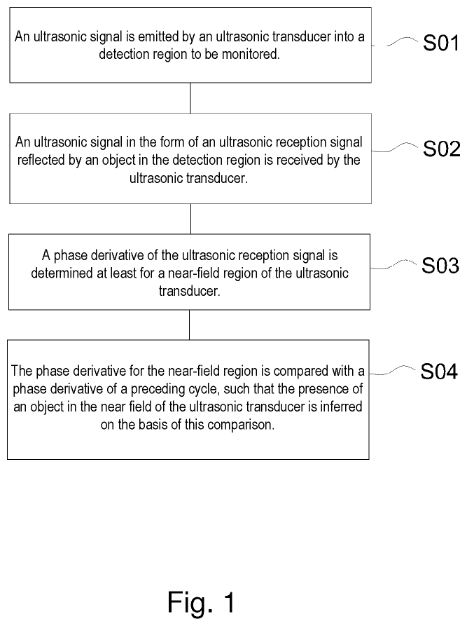

In the following, reference is made to FIG. 1. FIG. 1 shows the steps of a method for detecting an object or obstacle in a near field of an ultrasonic transducer according to the present invention in a first embodiment. The method comprises a cyclic acquisition of measured values, wherein each measured-value acquisition comprises:
a step S01, wherein an ultrasonic signal is emitted by an ultrasonic transducer into a detection region to be monitored;
a step S02, wherein an ultrasonic signal reflected by an obstacle in the detection region is received by the ultrasonic transducer in the form of an ultrasonic reception signal;
a step S03, wherein a phase derivative of the ultrasonic reception signal is determined at least for a near-field region of the ultrasonic transducer.

In particular, steps S01 to S03 are conducted cyclically one after another.

The method further comprises a step S04, wherein the phase derivative for the near-field region is compared with a phase derivative of a preceding cycle, and accordingly, the presence of an object or obstacle in the near field of the ultrasonic transducer is inferred on the basis of this comparison.

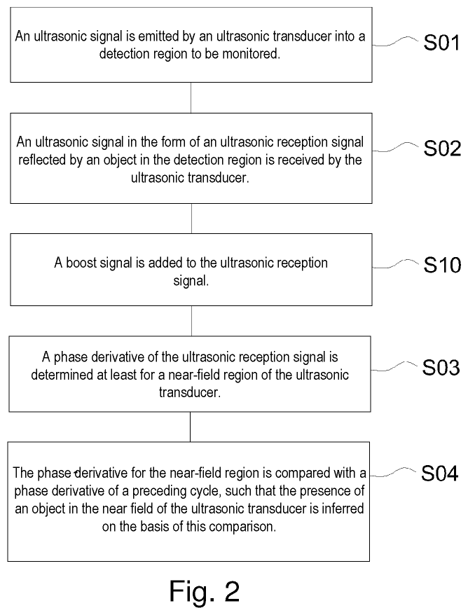

In the following, reference is made to FIG. 2. FIG. 2 shows a further embodiment of the method according to the invention, in which particularly the steps S01 to S04 correspond to the respective steps of FIG. 1. However, in a step S10, additionally a boost signal is added to the ultrasonic reception signal, prior to determining the phase derivative in step S03. In particular, at the end of the excitation of the ultrasonic transducer, or more precisely at the end of the ring-down region of the ultrasonic transducer, during the transition to the far-field region of the ultrasonic reception signal, the ultrasonic reception signal becomes so small that a phase derivative cannot be determined or can no longer be reliably determined, and the determination of the phase derivative is disturbed by noise. Thus, according to step S10, a boost signal is added to the ultrasonic reception signal in order to boost the ultrasonic reception signal and to enable a reliable determination of the respective phase derivative to be made. In this case, the magnitude of the boost signal is determined primarily on the basis of the amplitude of the ultrasonic reception signal. In particular, the boost signal is defined as a saturation signal minus the maximum amplitude of the ultrasonic reception signal, or more precisely, the envelope of the ultrasonic reception signal.

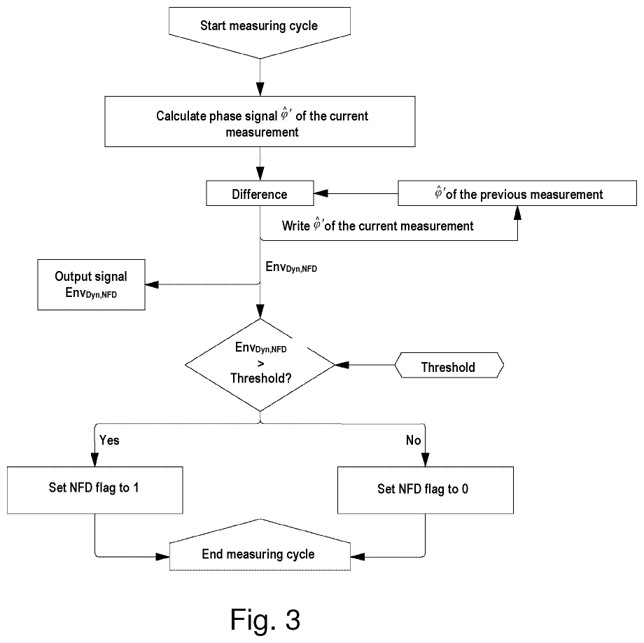

In the following, reference is made to the flowchart of FIG. 3. First, a measurement is started. In this current measurement, a phase derivative \hat{φ}′_{c} of the current measurement (“current”) and especially of the current ultrasonic reception signal is calculated. Subsequently, the difference between the phase derivative \hat{φ}′_{c} and the phase derivative of a previous measurement \hat{φ}′ₚ (“previous”) is determined and the phase derivative \hat{φ}′_{c} of the current measurement is stored for a subsequent measurement cycle. The result of the difference between the phase derivatives \hat{φ}′_{c} and \hat{φ}′ₚ is referred to in FIG. 3 as Env_{Dyn,NFD}. For example, this can be used for further evaluation. Alternatively or additionally, a comparison with a predetermined limit value or threshold is made. If the difference is greater than the predetermined threshold, an NFD flag is set to 1, indicating the presence of an object in the near field of the ultrasonic transducer. If the difference is less than the threshold, the NFD flag is set to 0, or left at 0, indicating that no object has been detected in the near field of the ultrasonic transducer. The NFD flag can be used particularly to generate a warning signal for the user to indicate the presence of an object in the near field of the ultrasonic transducer. The method reaches the end of the measurement cycle and a new measurement cycle can be started.

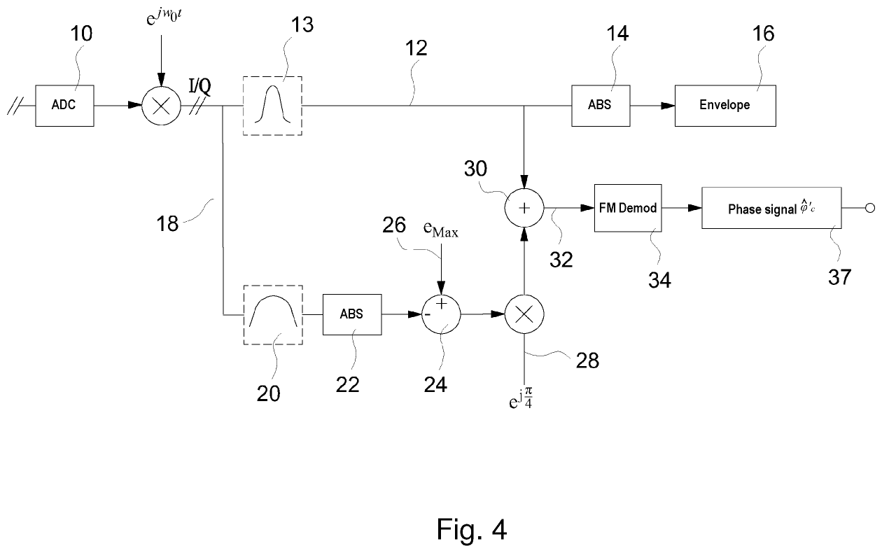

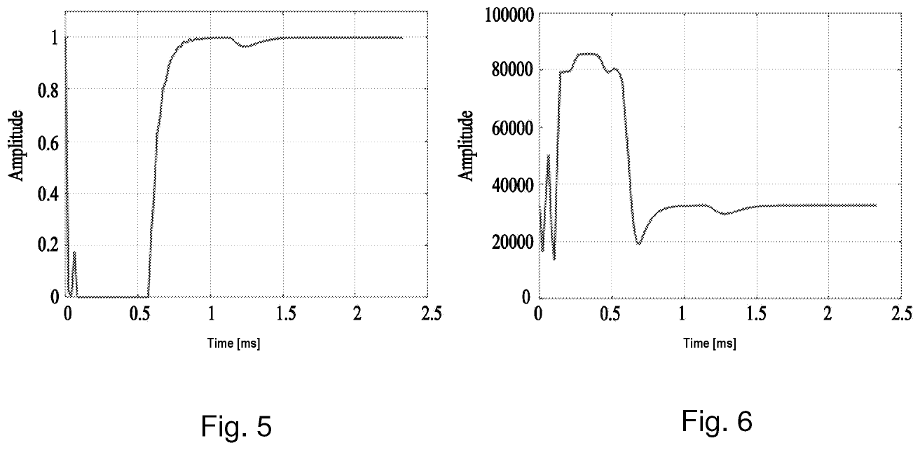

In the following, reference is made to FIG. 4. FIG. 4 shows a possible implementation of a signal path according to the present invention. The signal received by the ultrasonic transducer is converted into a digital signal by means of an analog-digital converter 10 and subsequently shifted into baseband. A filter 13 may be provided in a first signal path 12. Then, the absolute value 14 of the IQ signal is determined in order to determine an envelope 16. For example, a far-field detection can then be conducted by means of the envelope. A boost signal is determined in a second signal path 18. A filter 20 can similarly be provided in the second signal path. Thereafter, the absolute value 22 is determined again to determine the amplitudes of the ultrasonic reception signal. A saturation signal 26 is then provided, from which the amplitude of the ultrasonic reception signal is subtracted 24. An example of a boost signal is shown in FIG. 5. The boost signal is added 30 to the ultrasonic reception signal of the first signal path 12. The decreasing ultrasonic reception signal is amplified and boosted again by means of the boost signal especially after the end of the ring-down region. The addition takes place particularly in the baseband, wherein the boost signal can be added as a constant. In this case, the boost signal is uniformly distributed to I and Q components with a phase 28 of 45°. The summed signal 32 is illustrated by way of example in FIG. 6. Then, the phase derivative 34 is determined. For this purpose, in particular the equation

φ′(n)=I(n−1)·(Q(n−2)−Q(n))−Q(n−1)·(I(n−2)−I(n)),

is used to generate a phase signal \hat{φ}′_{c} 37.

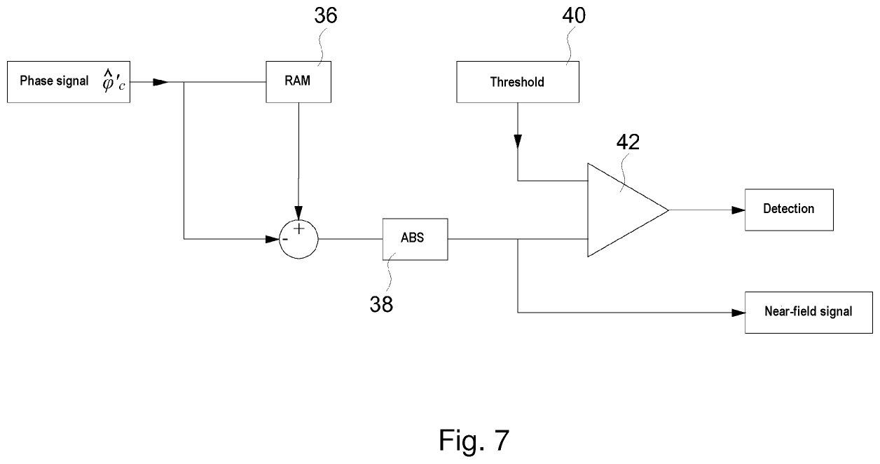

According to FIG. 7, the phase signal is \hat{φ}′_{c} subtracted from a phase signal \hat{φ}′ₚ from a memory 36. Subsequently, the absolute value 38 is formed and compared with a threshold 40 in a comparator 42. If the difference is greater than the predetermined threshold, it is inferred that an object is present in the near field of the ultrasonic transducer. Alternatively or additionally, the near-field signal 44 can be used for further evaluation. In particular, the location of the object within the near-field range can be determined using the near-field signal 44. For this purpose, the maximum of the difference can be used as the distance of the object from the ultrasonic transducer. Alternatively, the time at which the difference first exceeds the threshold value can be used to determine the distance of the object from the ultrasonic transducer.

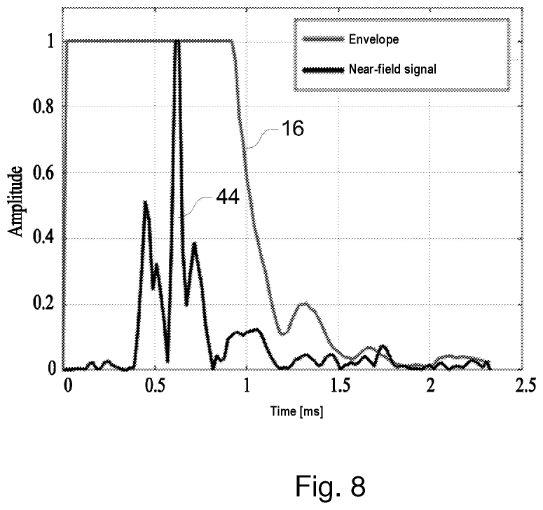

FIG. 8 shows an exemplary measurement using an envelope 16, which was determined according to the exemplary first signal path 12 of FIG. 4. It can be seen that no echo signal is detectable within the saturation region of the envelope, such that the presence of an object in the near-field region cannot be inferred directly on the basis of the envelope 16. Furthermore, the near-field signal 44 is illustrated in FIG. 8. It is clearly apparent from the near-field signal 44 that an object is present within the near-field region. In particular, the location or the distance of the object from the ultrasonic transducer can be inferred from the maximum of the near-field signal 44.

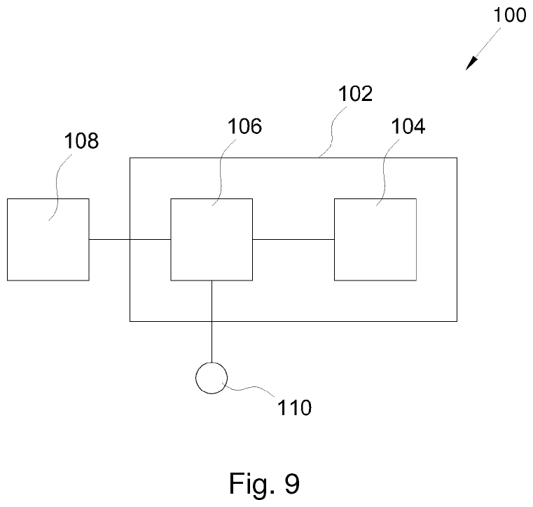

In the following, reference is made to FIG. 9. FIG. 9 shows a system 100 comprising a device 102. The device 102 comprises a memory unit 104 as well as a processor 106. The device 102 is connected to an ultrasonic transducer 108. Optionally, more than one ultrasonic transducer 108 can be provided. Instructions are stored in the memory unit 104 which, when executed by the processor 106, implement the steps of the method described above. In particular, the device 102 is connected indirectly or directly to a signal device 110, such that a warning signal can be generated by means of the signal device 110 when an object is detected in the near field of the ultrasonic transducer 108.

1. A method for detecting an object in a near field of an ultrasonic transducer, in particular as a parking aid for a vehicle, comprising the steps of:
cyclic acquisition of measured values, each cycle of the measured-value acquisition comprising:
emitting an ultrasonic signal by an ultrasonic transducer into a detection region to be monitored,
receiving, by the ultrasonic transducer, an ultrasonic signal reflected by an object in the detection region in the form of an ultrasonic reception signal,
determining a phase derivative of the ultrasonic reception signal at least for a near-field region of the ultrasonic transducer,
the method further comprising the step of:
comparing the phase derivative for the near-field region with a phase derivative of a preceding cycle, wherein the presence of an object in the near field of the ultrasonic transducer is inferred on the basis of the comparison.

2. The method according to claim 1, wherein the near-field region comprises at least partially a ring-down region of the ultrasonic transducer.

3. The method according to claim 1, wherein a boost signal is added to the ultrasonic reception signal prior to determining the phase derivative.

4. The method according to claim 3, wherein the boost signal is defined as a saturation signal minus the maximum amplitudes of the ultrasonic reception signal.

5. The method according claim 1, wherein an evaluation window is defined in the near-field region of the ultrasonic transducer, wherein the comparison is made only in the evaluation window.

6. The method according to claim 5, wherein the position and width of the evaluation window are selected as a function of one or more of the decay time of the ultrasonic transducer, the temperature, the excitation current of the ultrasonic transducer, the quality factor of the ultrasonic transducer, the excitation frequency of the ultrasonic transducer, the number of excitation pulses, and the excitation duration of the ultrasonic transducer.

7. The method according to claim 1, wherein the phase derivative is determined from IQ values of the ultrasonic reception signal.

8. The method according to claim 7, wherein the phase derivative φ′(n) is determined according to
φ′(n)=I(n−1)·(Q(n−2)−Q(n))−Q(n−1)·(I(n−2)−I(n)),
wherein n denotes a discrete time step, I denotes the in-phase values and Q denotes the quadrature values of the ultrasonic reception signal.

9. The method according to claim 1, wherein an envelope is determined from the ultrasonic reception signal in each cyclic measured-value acquisition.

10. The method according to claim 1, wherein comparing the phase derivative for the near-field region with a phase derivative of a preceding cycle comprises determining a difference between the phase derivatives and, if the difference is greater than a predetermined limit value, inferring the presence of an obstacle in the near field of the ultrasonic transducer.

11. A device, in particular a microelectronic circuit, for connection to at least one ultrasonic transducer, wherein the device comprises a memory unit and a processor, wherein the memory unit stores instructions which, when executed by the processor, implement the steps of the method according to claim 1.

12. A system comprising a device according to claim 11 and at least one ultrasonic transducer, which is connected to the device.
